(19) United States
(12) Patent Application Publication
(10) Pub. No.: US 2011/0279367 A1
(43) Pub. Date: Nov. 17, 2011

(54) PRESENTER

(75) Inventor: YAN-MEI YANG, CHIAYI CITY (TW)

(73) Assignee: HOWAY CORP., KAOHSIUNG CITY (TW)

(21) Appl. No.: 12/778,417

(22) Filed: May 12, 2010

(51) Int. Cl. G06F 3/033

(52) U.S. Cl. 345/158

(57) ABSTRACT

A presenter includes a main body, a light source, a pointing input unit and a wireless transmission unit. The light source can be a laser diode or any other light-emitting element capable of emitting a laser beam. The pointing input unit can be a magnetically sensitive pointing unit or an optical cursor controller. The pointing input unit is operable to output a pointing control signal to a host via the wireless transmission unit. The presenter is capable of projecting a laser beam and controlling a cursor of the host device via the wireless transmission unit.

### BACKGROUND OF THE INVENTION

1. Field of the Invention

The present invention relates generally to a presenter, and more particularly to a presenter including a light source and a mini-size pointing input unit. The light source of the presenter serves to project a laser beam outward to form a light point on a screen. The presenter wirelessly connects and communicates with an external computer and a relevant projector equipment via a wireless transmission unit to control a cursor. The presenter is more easily controllable and is able to provide various additional functions.

2. Description of the Related Art

In a conventional presentation, a projector is used to project images of data to a projection screen, a wall or a vertical plane. Also, a presenter often uses a laser pointer pen to point at contents of the image to facilitate the demonstration by a laser beam. However, the presenter needs an assistant to replace the slides in convenience. This leads to waste human resources and requires a tacit understanding between the presenter and the assistant in operation. If the slide is replaced by the presenter himself/herself without any assistant, the burden on the presenter will increase. This will result in distraction of the presenter to affect the presentation quality.

In an advanced presentation, a projection device is connected to a computer, whereby the pictures on the screen of the computer can be directly projected onto a projection screen or a wall. In this case, a presenter can solely and directly operate the computer to change the pictures for the presentation. This can not only save human resources, but also promote the presentation efficiency. However, the presenter still needs to operate the computer and in the meanwhile to point the laser beam at the content in practice. During the presentation, the presenter cannot leave the computer and it often takes place that the audiences can simply hear the voice of the presenter without seeing the presenter. As a result, the presenter cannot directly and interactively face the audiences. This will affect the presentation quality.

### SUMMARY OF THE INVENTION

It is therefore a primary object of the present invention to provide a presenter, which can be easily operated to control a computer and relevant projection equipments so as to reduce the burden on a presenter and promote the presentation efficiency.

It is a further object of the present invention to provide the above presenter, which also serves as a laser pointer pen to provide pointing function in a presentation.

To achieve the above and other objects, the presenter of the present invention comprises: a main body; a light source disposed on the main body for projecting a laser beam outward; a pointing input unit disposed on the main body and operable to output a pointing control signal; and a wireless transmission unit disposed in the main body for wirelessly connecting and communicating with an external electronic product.

In the above presenter, the pointing input unit is a magnetically sensitive pointer unit.

In the above presenter, the pointing input unit is an optical cursor controller.

In the above presenter, a capacitive sensor pad is disposed on the surface of the main body. Within the capacitive sensor pad, a one-dimensional sensor array unit and a touch control unit are disposed. The one-dimensional sensor array unit serves to sense capacitance change signal caused by an external article that touches the capacitive sensor pad. The touch control unit serves and analyzes multiple capacitance change signals generated by the one-dimensional sensor array unit to generate a control signal containing information of direction and distance of the external article sliding along the one-dimensional sensor array unit.

The present invention can be best understood through the following description and accompanying drawings, wherein:

### BRIEF DESCRIPTION OF THE DRAWINGS

FIG. 1 is a perspective top view of the presenter of the present invention; and

FIG. 2 is a perspective bottom view of the presenter of the present invention.

### DETAILED DESCRIPTION OF THE PREFERRED EMBODIMENTS

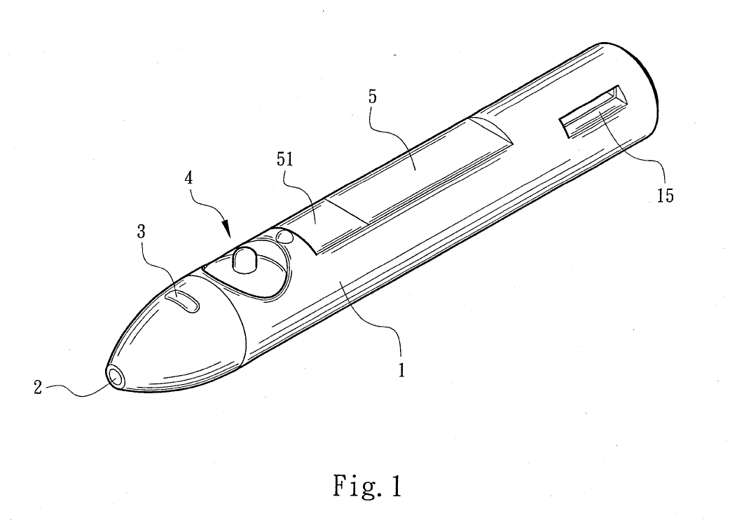

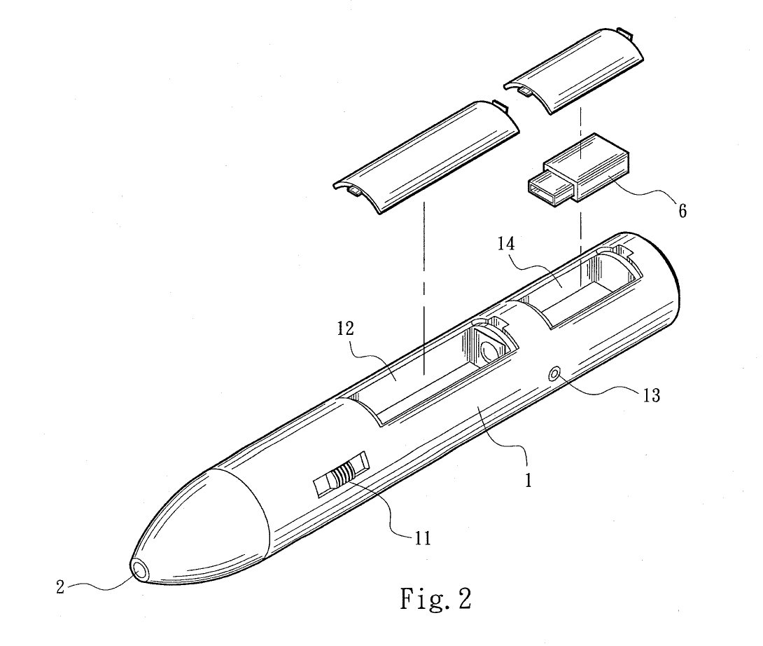

Please refer to FIGS. 1 and 2. The presenter of the present invention comprises a main body 1, a light source 2, a wireless transmission unit 3, a pointing input unit 4 and a capacitive sensor pad 5. The light source 2, the pointing input unit 4 and the capacitive sensor pad 5 are arranged separately on a surface of the main body 1. The wireless transmission unit 3 is disposed inside the main body 1. In addition, on the surface of the main body 1 can be arranged a switch 11, a recess 12 for cell, a power socket 13 for connecting with an external DC power supply and a memory card slot 15.

The light source 2 can be a laser diode or any other light-emitting element capable of emitting a laser beam. Preferably, the light source 2 is positioned at an end of the main body 1 or a portion of the main body 1, where the light source 2 will not be obscured when holding the main body 1.

The pointing input unit 4 is a magnetically sensitive pointer unit. The magnetically sensitive pointer unit at least comprises a magnetic element and multiple magnetoelectric transducers arranged around the magnetic element. The magnetic element is connected to a control stick for driving the magnetic element to change its position. Accordingly, the magnetic field distribution can be changed and the magnetoelectric transducers can sense the change to generate the plural number of different intensity electrical signals according to the distances of the relative positions between the magnetic element and the magnetoelectric transducers. Moreover, the magnetically sensitive pointer unit can further include a pointing controller and a switch as necessary. The pointing controller can compare the differences between the multiple electrical signals to generate a pointing control signal corresponding to the direction and distance of the relative positions. Also, the pointing controller can compare the differences between the multiple electrical signals at different times to generate a pointing control signal corresponding to the direction and distance of the differences. The switch is disposed between the magnetic element and the multiple magnetoelectric transducers. When an external force is applied to the magnetic element, the magnetic element contacts the switch as a triggering for the switch to generate a first switching signal. When the switch is continuously triggered for many times, the maintaining time of the triggering is calculated. When the maintaining time is longer than a preset reference time, a second switching signal is generated. Furthermore, in practice, the pointing input unit 4 can be alternatively and widely used in current optical cursor controller to provide the same basic control function, and the magnetically sensitive pointer unit and the optical cursor controller both are mature techniques currently widely used in various fields.

The capacitive sensor pad 5 can be positioned on a middle section of the main body 1. The capacitive sensor pad 5 at least comprises a one-dimensional sensor array unit and a touch control unit. The one-dimensional sensor array unit serves to sense capacitance change signal caused by an external article that touches the capacitive sensor pad 5. The touch control unit serves and analyzes multiple capacitance change signals generated by the one-dimensional sensor array unit, to generate a control signal containing information of direction and distance of the external article sliding along the one-dimensional sensor array unit. The capacitive sensor pad 5 is able to detect one single touch operation to generate a fourth switching signal, or multiple touch operations during a reference time period to generate a fifth switching signal. Also, the capacitive sensor pad 5 can be provided with a pushbutton section 51 as necessary. When it be touched, the pushbutton section 51 is able to generate a third switching signal. Taiwanese Patent Nos. 200945126, 200933454, 1316679, M361675, M361674, M337792, M315377, etc. of this inventor can be referred to for the application techniques related to the sensor pad.

The wireless transmission unit 3 is disposed in the main body 1. The wireless transmission unit 3 can be a short-distance wireless communication mechanism such as an infrared wireless communication device or a radio wireless communication device. Alternatively, the wireless transmission unit 3 can be a wireless transmission mechanism using a communication protocol for ZigBee, Bluetooth, ultra-wideband communication or the like. The wireless transmission unit 3 serves to wirelessly connect and communicate with an external computer or projector or relevant electronic products for transmitting the respective control signals outward.

In use, the power supply for the light source 2 and other components is controlled by means of the switch 11. When it turned on, the light source 2 projects a laser beam outward to form a light point on a screen. When the other components in the main body 1 are powered on, a presenter can operate the pointing input unit 4 or the capacitive sensor pad 5 to generate various control signals for moving the cursor. The control signals can be further wirelessly transmitted outward by means of the wireless transmission unit 3, then be received by an external computer connected to a projector or another presenting unit. In this case, the cursor is synchronously moved on the presented image to satisfy the needs of indication in presentation. A relevant memory card can be inserted into the memory card slot 15 to be connected with the computer or the presenting unit for storing relevant data.

The light source 2 can be turned on/off by means of the switch 11 or the first switching signal or the third switching signal.

In practical application, a transceiver module receptacle 14 is disposed on the surface of the main body 1 for accommodating a USB wireless transceiver module 6. The USB wireless transceiver module 6 mainly includes a USB plug for connecting with a USB socket of an external electronic device (the aforesaid computer or the presenting unit). In addition, the USB wireless transceiver module 6 is disposed within a wireless transmission system which directly connected with the wireless transmission unit 3. Accordingly, the main body 1 can be directly and conveniently connected to the external computer or presenting unit via the wireless transmission unit 3 and the USB wireless transceiver module 6 without previously installing a driver to the external computer or presenting unit nor taking into consideration whether the external computer or presenting unit is built within a corresponding wireless transmission system. Therefore, the presenter of the present invention can be more conveniently used.

Furthermore, at least one memory card can be inserted into the memory card slot 15 of the main body for a user to easily carry the memory card which stores the files to present. The memory card slot has such a dimension to insert a memory card which is compatible with a common computer mainframe or a presenting equipment.

In conclusion, the presenter of the present invention is able to more easily and more efficiently control a computer and relevant projector equipment wirelessly to promote the presentation quality.

The above embodiments are only used to illustrate the present invention, not intended to limit the scope thereof. Many modifications of the above embodiments can be made without departing from the spirit of the present invention.

What is claimed is:

1. A presenter at least comprises:
a main body;
a light source disposed on the main body for projecting a laser beam outward;
a pointing input unit disposed on the main body and operable to generate a pointing control signal; and
a wireless transmission unit disposed in the main body for wirelessly connecting and communicating with an external electronic device.

2. The presenter as claimed in claim 1, wherein the pointing input unit is a magnetically sensitive pointing unit.

3. The presenter as claimed in claim 2, wherein the magnetically sensitive pointing unit at least comprises a plurality of magnetoelectric transducers and a magnetic element; and the plurality of magnetoelectric transducers are configured to generate a plurality of electrical signals which have intensity according to the relative positions between the magnetic element and the magnetoelectric transducers.

4. The presenter as claimed in claim 3, wherein the magnetically sensitive pointing unit further comprises a pointing controller, the pointing controller are configured to compare the differences between the plurality of electrical signals to generate the pointing control signal corresponding to the relative positions.

5. The presenter as claimed in claim 3, wherein the magnetically sensitive pointing unit further comprises a pointing controller, the pointing controller is configured to compare the differences between the plurality of electrical signals at different times to generate the pointing control signal corresponding to the differences.

6. The presenter as claimed in claim 3, wherein the magnetically sensitive pointing unit further comprises a switch disposed between the magnetic element and the plurality of magnetoelectric transducers, whereby an external force is applied to the magnetic element, which touches the switch as a triggering for the switch to generate a first switching signal.

7. The presenter as claimed in claim 4, wherein the magnetically sensitive pointing unit further comprises a switch disposed between the magnetic element and the plurality of magnetoelectric transducers, whereby an external force is applied to the magnetic element, which touches the switch as a triggering for the switch to generate a first switching signal.

8. The presenter as claimed in claim 5, wherein the magnetically sensitive pointing unit further comprises a switch disposed between the magnetic element and the plurality of magnetoelectric transducers, whereby an external force is applied to the magnetic element, which touches the switch as a triggering for the switch to generate a first switching signal.

9. The presenter as claimed in claim 6, wherein the switch is able to calculate the maintaining time of the triggering, whereby when the maintaining time is longer than a reference time, the switch generates a second switching signal.

10. The presenter as claimed in claim 1, wherein the pointing input unit is an optical cursor controller.

11. The presenter as claimed in claim 1, comprises: a capacitive sensor pad disposed on the surface of the main body, wherein a one-dimensional sensor array electrically connected to a touch control unit is disposed on the capacitive sensor pad; the one-dimensional sensor array is configured to sense capacitance change when an external article touches the capacitive sensor pad; the touch control unit is configured to analyze the plurality of capacitance change from the one-dimensional sensor array unit and to generate a control signal containing information of sliding direction and distance of the external article along the one-dimensional sensor array unit.

12. The presenter as claimed in claim 11, wherein the capacitive sensor pad is provided with a pushbutton section, whereby when touched, the pushbutton section generates a third switching signal.

13. The presenter as claimed in claim 11, wherein the capacitive sensor pad is able to detect one single click operation to generate a fourth switching signal.

14. The presenter as claimed in claim 11, wherein the capacitive sensor pad is able to detect multiple clicks operation during a reference time period to generate a fifth switching signal.

15. The presenter as claimed in claim 1, wherein the wireless transmission unit is selected from a group of communication protocols for ZigBee, Bluetooth and ultra-wideband communication.

16. The presenter as claimed in claim 1, wherein the wireless transmission unit is a short-distance wireless communication unit selected from a group consisting of infrared wireless communication device and radio wireless communication device.

17. The presenter as claimed in claim 1, wherein a switch is disposed on the surface of the main body for controlling power supply of the respective components.

18. The presenter as claimed in claim 1, wherein a transceiver module receptacle is disposed in the main body for accommodating a USB wireless transceiver module.

19. The presenter as claimed in claim 1, wherein a cell chamber and a power supply circuit are disposed in the main body.

20. The presenter as claimed in claim 1, wherein a memory card slot is disposed on the main body.
